(19) United States
(12) Patent Application Publication
(10) Pub. No.: US 2013/0235416 A1
(43) Pub. Date: Sep. 12, 2013

(54) BIN-PACKING APPROACH TO PRODUCTION JOB SCHEDULING ON A CLOUD INFRASTRUCTURE

(71) Applicants: Lee Coy Moore, Penfield, NY (US); Barry Glynn Gombert, Rochester, NY (US)

(72) Inventors: Lee Coy Moore, Penfield, NY (US); Barry Glynn Gombert, Rochester, NY (US)

(73) Assignee: XEROX CORPORATION, Norwalk, CT (US)

(21) Appl. No.: 13/416,386

(22) Filed: Mar. 9, 2012

(51) Int. Cl. G06F 3/12

(52) U.S. Cl. 358/1.15

(57) ABSTRACT

A method of scheduling a print job in a print production system may include identifying one or more print jobs having a start time within a rental period, identifying one or more logical devices that are operating during the rental period and determining a processing schedule associated with the rental period. The method may include determining whether the processing schedule comprises an idle period, in response to the processing schedule comprising an idle period, determining whether a future print job can be processed during the idle period, in response to determining that the future print job can be processed during the idle period, assigning the future print job to at least a portion of the idle period on the processing schedule, and instructing the identified logical devices to process the one or more identified print jobs according to the processing schedule.

### BACKGROUND

Cloud computing services, such as production services, offer customers many benefits including reduced capital expenditures, scalability, managed upgrades and access to new workflows. Often, Infrastructure-as-a-Service cloud systems rent the use of virtual machines by the hour. Production jobs typically have an associated deadline by which the production job needs to be completed. Accordingly, it is important to schedule production jobs efficiently in order to maximize the use of a virtual machine during a rental period and therefore minimize the production cost.

### G. SUMMARY

This disclosure is not limited to the particular systems, methodologies or protocols described, as these may vary. The terminology used in this description is for the purpose of describing the particular versions or embodiments only, and is not intended to limit the scope.

As used in this document, the singular forms “a,” “an,” and “the” include plural reference unless the context clearly dictates otherwise. Unless defined otherwise, all technical and scientific terms used herein have the same meanings as commonly understood by one of ordinary skill in the art. All publications mentioned in this document are incorporated by reference. All sizes recited in this document are by way of example only, and the invention is not limited to structures having the specific sizes or dimensions recited below. Nothing in this document is to be construed as an admission that the embodiments described in this document are not entitled to antedate such disclosure by virtue of prior invention. As used herein, the term “comprising” means “including, but not limited to.”

In an embodiment, a method of scheduling a print job in a print production system may include identifying one or more print jobs having a start time within a rental period, identifying one or more logical devices that are operating during the rental period and determining, by a computing device, a processing schedule associated with the rental period. Determining a processing schedule may include, for each identified print job, assigning the identified print job to a logical device from the one or more identified logical devices. Processing of each of the identified print jobs by the assigned logical device may begin at the start time associated with the print job. The method may include determining whether the processing schedule comprises an idle period, in response to the processing schedule comprising an idle period, determining whether a future print job can be processed during the idle period, in response to determining that the future print job can be processed during the idle period, assigning the future print job to at least a portion of the idle period on the processing schedule, and instructing the identified logical devices to process the one or more identified print jobs according to the processing schedule.

In an embodiment, a system for scheduling a print job in a print production system may include a computing device and a computer-readable storage medium in communication with the computing device. The computer-readable storage medium may include one or more programming instructions that, when executed, cause the computing device to identify one or more print jobs having a start time within a rental period, identify one or more logical devices that are operating during the rental period, and determine a processing schedule associated with the rental period. Determining a processing schedule may include, for each identified print job, assigning the identified print job to a logical device from the one or more identified logical devices. Processing of each of the identified print jobs by the assigned logical device may begin at the start time associated with the print job. The computer-readable storage medium may include one or more programming instructions that, when executed, cause the computing device to determine whether the processing schedule comprises an idle period, in response to the processing schedule comprising an idle period, determine whether a future print job can be processed during the idle period, in response to determining that the future job can be processed during the idle period, assign the future print job to at least a portion of the idle period on the processing schedule, and instruct the identified logical devices to process the one or more identified print jobs according to the processing schedule.

In an embodiment, a method of scheduling a job may include identifying one or more jobs having a start time within a rental period, identifying one or more logical devices that are operating during the rental period, and determining, by a computing device, a processing schedule associated with the rental period. Determining a processing schedule may include, for each identified job, assigning the identified job to a logical device from the one or more identified logical devices. Processing of each of the identified jobs by the assigned logical device may begin at the start time associated with the job. The method may include determining whether the processing schedule comprises an idle period, in response to the processing schedule comprising an idle period, determining whether a future job can be processed during the idle period, in response to determining that the future job can be processed during the idle period, assigning the future job to at least a portion of the idle period on the processing schedule, and instructing the identified logical devices to process the one or more identified jobs according to the processing schedule.

### BRIEF DESCRIPTION OF THE DRAWINGS

Aspects, features, benefits and advantages of the present invention will be apparent with regard to the following description and accompanying drawings, of which:

FIG. 1 illustrates a block diagram of an illustrative production system according to an embodiment.

FIG. 2 illustrates a block diagram of an illustrative production center according to an embodiment.

FIG. 3 illustrates a flow diagram for an illustrative method of scheduling a job according to an embodiment.

FIG. 4 illustrates scheduling information associated with example jobs according to an embodiment.

FIGS. 5 and 6 illustrate portions of example processing schedules according to an embodiment.

FIG. 7 illustrates a block diagram of hardware that may be used to contain or implement program instructions according to an embodiment.

### DETAILED DESCRIPTION

The following terms shall have, for purposes of this application, the respective meanings set forth below:

An “idle period” is a period of time in a rental period during which a logical device is not processing a job.

A “job” refers to a logical unit of work that is to be completed for a customer. In a print environment, a job may include one or more print jobs from one or more clients. A “future job” refers to a job scheduled to be processed during a future rental period.

A “logical device” is a representation of a physical device that uniquely identifies the corresponding physical device. For example, a logical device may be a software representation of a physical device that executes programs or applications similar to a physical device.

A “physical device” is a physical resource such as a computing device, a print device, a computer-readable storage medium and/or the like.

A “prepress operation” refers to a preparatory service that is performed on a job before the job reaches a production stage. Example prepress operations in a print production environment may include, without limitation, converting a print job from a first page description language (“PDL”) to a second PDL, performing color management operations, preflighting to identify potential print incompatibilities, performing imposition, rotation, mirroring, cropping and/or resizing in a print job or a portion of a print job, joining print jobs, adding one or more pressmarks, such as color bars, and/or adding one or more of a page number, a Bates stamp, text, an image watermark and a barcode.

A “print job” refers to a job processed in a print production system. For example, a print job may include producing credit card statements corresponding to a certain credit card company, producing bank statements corresponding to a certain bank, printing a document, or the like. Although the disclosed embodiments pertain to print jobs, the disclosed methods and systems can be applied to jobs in general in other production environments, such as automotive manufacturing, semiconductor production and the like.

A “print shop” refers to an entity that includes a plurality of print devices, such as printers, cutters, collators and the like. A print shop may be a freestanding entity, including one or more print devices, or it may be part of a corporation or other entity. Additionally, a print shop may communicate with one or more servers by way of a communications network, such as the Internet, an intranet, a LAN, a WAN, a wireless network and/or the like.

A “processing schedule” is a schedule of processing information associated with one or more jobs over one or more rental periods. A processing schedule may identify start times, processing times, completion times and/or logical devices associated with one or more jobs over one or more rental periods.

A “rental period” refers to a time interval by which logical device usage is rented or otherwise purchased. For example, logical devices may be rented by the hour, so each hour may be considered a rental period.

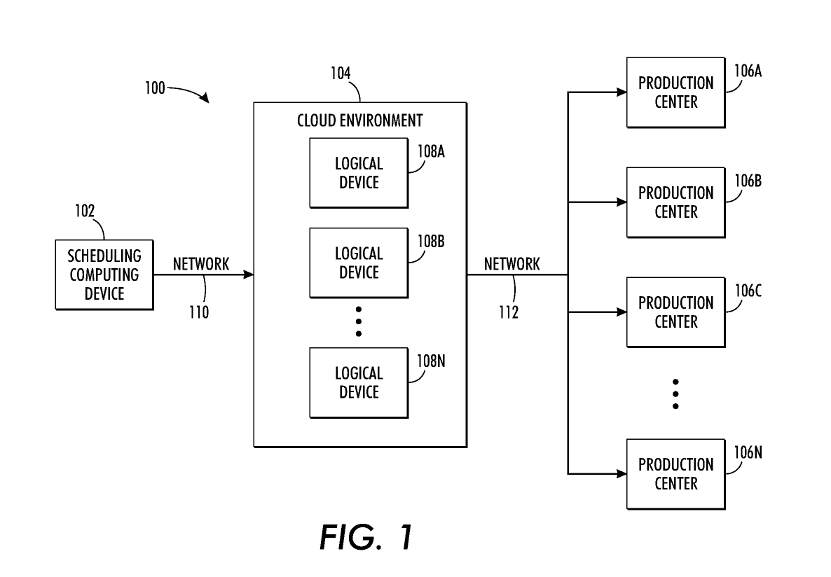

FIG. 1 illustrates an example of a production system according to an embodiment. As illustrated by FIG. 1, the production system 100 may include a scheduling computing device 102, a cloud environment 104 and one or more production environments 106a-N. The scheduling computing device 102 may be a computing device configured to transmit one or more jobs to the cloud environment 104. In an embodiment, the scheduling computing device 102 may determine an order in which jobs are to be processed. In an embodiment, the scheduling computing device 102 may determine by which logical device in the cloud environment a job or a portion of a job is to be processed. Although FIG. 1 depicts the scheduling computing device 102 as removed from the cloud computing environment 104, the scheduling computing device may be a part of the cloud environment within the scope of this disclosure.

In an embodiment, a scheduling computing device 102 may be in communication with a cloud environment 104 via a network 110. In an embodiment, a network 110 may be the Internet. In an alternate embodiment, other networks, such as an intranet, WAN or LAN may be used.

In an embodiment, a cloud environment 104 may include one or more logical devices 108a-N. The logical devices 108a-N may each be associated with a particular entity, such as a cloud service provider. In an embodiment, the logical devices 108a-N may be associated with a function or production process associated with one or more jobs. For example, in a print production system, a cloud environment 104 may include one or more logical devices 108a-N each capable of performing one or more prepress operations on one or more jobs. In an embodiment, one or more logical devices 108a-N in a cloud environment 104 may be located remotely from one or more other logical devices 108a-N in the cloud environment.

In an embodiment, a cloud environment 104 may be in communication with one or more production centers 106a-N via network 112. In an embodiment, a network 112 may be the Internet. In an alternate embodiment, other networks, such as an intranet, WAN or LAN may be used. For example, in a print production system, a cloud environment 104 may be in communication with one or more print shops via a network 112. One or more of the production centers 106a-N may be located remotely from the cloud environment 104. In an embodiment, one or more of the production centers 106a-N may be located remotely from one another. For example, one production center 106a may be located in New York, while another production center 106b may be located in Florida.

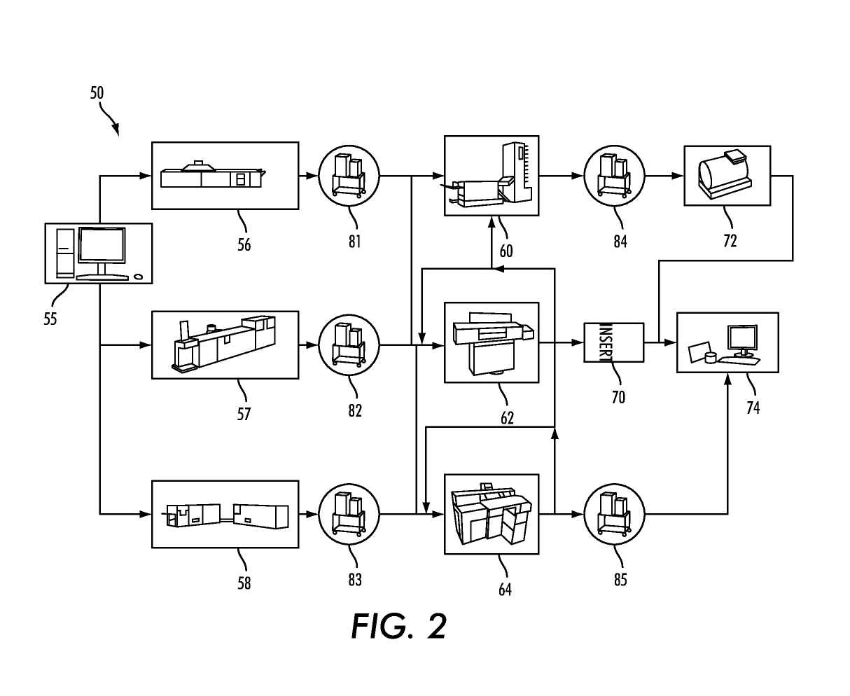

FIG. 2 shows an example of a production center 50, in this case, examples of elements of a print shop. Print jobs may enter the print shop manually or electronically and be collected at an electronic submission system 55 such as a computing device and/or scanner. Jobs are sorted and batched at the submission system or another location before being delivered to one or more print engines such as a color printer 56, black-and-white printer 57 and/or a continuous feed printer 58. Jobs may exit the print engine and be delivered to one or more finishing devices or areas such as a collator 60, cutter 62, and/or binder 64. The finishing areas may include automatic or manual areas for such finishing activities and they also may include an automatic or manual inserter 70. Finally, jobs may move to a postage metering station 72 and/or shipping station 74. Jobs may move from one location to another in the print shop by automatic delivery or manual delivery such as by hand or by one or more paper carts 81-85. Although the disclosed embodiments pertain to document production systems, the disclosed methods and systems can be applied to production systems in general.

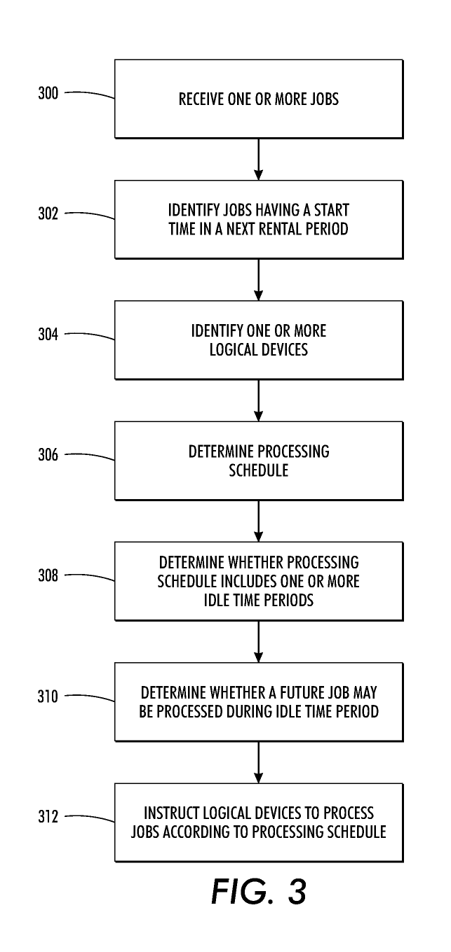

FIG. 3 illustrates a method of scheduling a job according to an embodiment. As illustrated by FIG. 3, one or more jobs may be received 300. In an embodiment, one or more jobs may be received 300 by a scheduling computing device in a print production system. In an embodiment, one or more of the received jobs having a start time during a next rental period may be identified 302. A next rental period may be a rental period that occurs immediately after the rental period during which the method illustrated by FIG. 3 is performed.

In an embodiment, a start time of a job may be determined based on, at least in part, a turnaround time associated with a received job. A turnaround time may be an amount of time within which a job must be processed. In an embodiment, a turnaround time may be associated with a job. In an embodiment, a turnaround time may be determined from a service agreement with a customer that submitted the job for processing. For example, a customer may have a service agreement with a job processing service providing that a job must be completed within a certain time period after submission. In an embodiment, if a job is not completed within the certain time period, a penalty, such as a financial penalty, may be imposed on the service provider.

In an embodiment, a start time of a job may be determined based on, at least in part, a processing time associated with the job. A processing time may refer to an amount of time needed to completely process a job, or an amount of time needed to process a portion of a job. For example, a processing time may refer to an amount of time to perform prepress operations and processing operations on a job. Alternatively, a processing time may refer to the amount of time needed to perform only prepress operations or processing operations on a job. For example, if a job is to be cropped, resized, printed and bound, a processing time associated with the job may be the amount of time needed to crop, resize, print and bind the job. In an embodiment, a job that begins processing at a current time for the processing time may complete on or before a completion deadline associated with the job.

In an embodiment, a receipt time associated with a job may be determined. A receipt time may refer to the time at which a job is received for processing. A completion time may be determined based on the receipt time and the turnaround time associated with the job. For example, a completion time may be a time equal to the receipt time plus the turnaround time. For instance, if a job is received at 12 p.m., and the turnaround time associated with the job is five hours, the completion time may be 5 p.m.

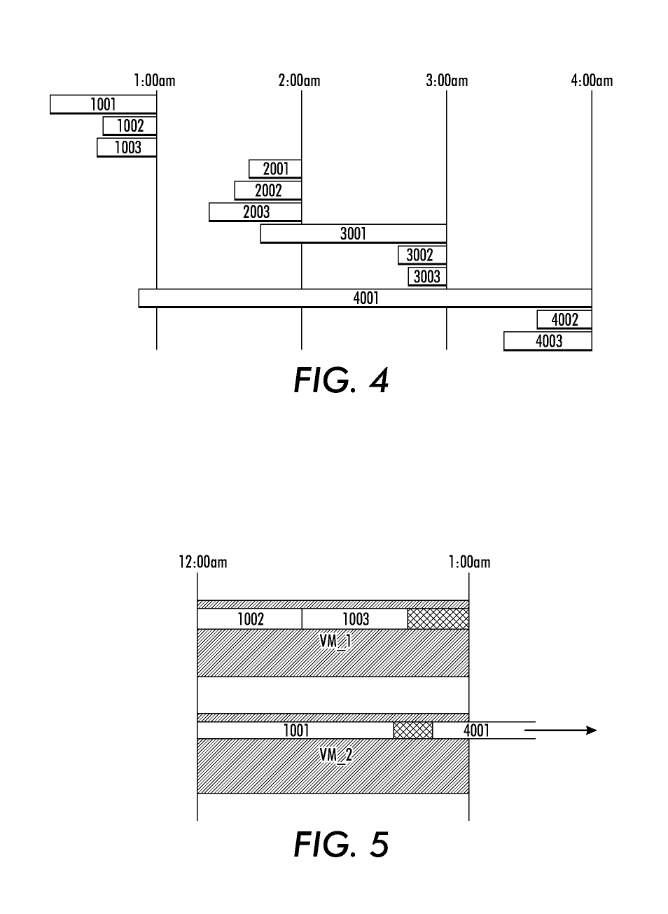

In an embodiment, a start time associated with a job may be a time at which the job starts such that the processing of the job completes at the completion time. For example, if the completion time associated with a job is 5 p.m. and the processing time associated with the job is two hours, the start time associated with the job is 3 p.m. FIG. 4 illustrates examples of start times, processing times and completion times over four rental periods according to an embodiment.

In an embodiment, one or more logical devices may be identified 304. The identified logical devices may be logical devices that are scheduled to process one or more jobs during the next rental period.

In an embodiment, logical devices that are assigned jobs which are rolling over from a previous rental period but completing in the upcoming rental period may be identified 304. For example, if a logical device processes Job A from 12:30 a.m. until 1:30 a.m., it may be identified 304 during a determination that occurs prior to 1 a.m. because the logical device will be processing a job between the next rental period (i.e., 1 a.m.-1:30 a.m.) and the job will be completed within the next rental period. As such, usage of the logical device will already have been rented to complete Job A, and will have free time between 1:30 a.m. and 2 a.m. that can be used to process another job.

In an embodiment, one or more logical devices may be identified 304 based on the number of jobs to be processed during a rental period. For example, referring to FIG. 4, two logical devices may be identified 304 as part of the determination for the 12 a.m.-1 a.m. period because two logical devices may be needed to process Jobs 1001, 1002, 1003 and 4001 during the period. In an embodiment, if the number of logical devices that are identified 304 is greater than the number of logical devices that were operating during the prior rental period, additional logical devices may be activated. For example, if three logical devices are being used during a current rental period, but four logical devices are needed to process jobs in the next rental period, an additional logical device may be brought online.

Similarly, if the number of logical devices that are identified 304 is less than the number of logical devices that are operating during the prior rental period, one or more logical devices may be released. For example, if three logical devices are being used in a current rental period, but only two logical devices are needed to process jobs in the next rental period, one logical device may be released.

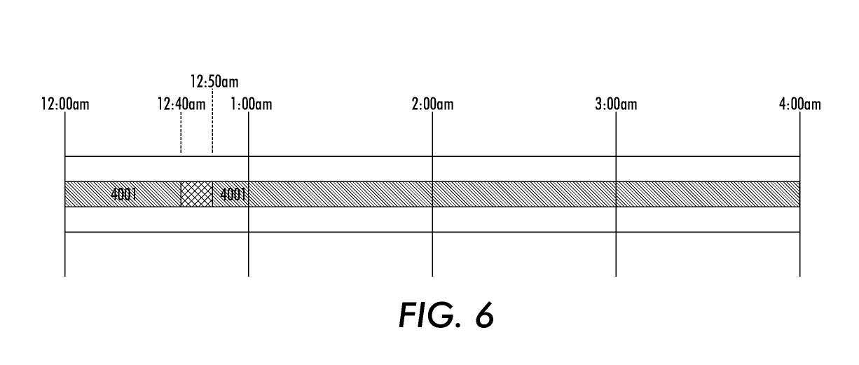

In an embodiment, a processing schedule associated with the next rental period may be determined 306. A processing schedule may identify the start time, the completion time and the processing time associated with one or more jobs over one or more rental periods. A processing schedule may also identify one or more logical devices to which the one or more jobs are assigned. FIG. 5 illustrates an example of a processing schedule according to an embodiment. Alternate processing schedules may be used within the scope of this disclosure.

In an embodiment, a processing schedule may include an allocation of one or more jobs or one or more portions of one or more jobs to one or more logical devices. An allocation may be determined in advance of an upcoming logical device rental period. For example, a logical device may be rented by the hour, so an allocation may be determined in advance of every hour during which jobs are to be processed. For instance, an allocation may be determined a few minutes in advance of every hour during which jobs are to be processed.

In an embodiment, one or more jobs or portions of jobs may be allocated to an identified logical device based on the estimated duration of the job or the job portion. FIG. 5 illustrates an example of an assignment of Jobs 1001, 1002, 1003 and 4001 from FIG. 4 to two logical devices according to an embodiment. As illustrated by FIG. 5, Job 1002 and Job 1003 may be assigned to Logical Device 1, and Job 1001 and a portion of Job 4001 may be assigned to Logical Device 2.

In an embodiment, jobs that have processing times, the sum of which is less than the duration of a rental period may be processed sequentially without any time delay between them. For example, referring to FIG. 5, Job 1002 and Job 1003 both have estimated completion times of less than an hour, and the sum of the processing times for Job 1002 and Job 1003 is less than an hour. As such, Job 1002 and Job 1003 may be processed sequentially by Logical Device 1 with minimal delay between the end of processing Job 1002 and the beginning of the processing of Job 1003 as illustrated by FIG. 5.

In an embodiment, a job that is to be processed over two or more rental periods may be allocated to a virtual machine such that a portion of the job that is less than a rental period is assigned to an earlier rental period and one or more portions of the job that fill a rental period are assigned to one or more subsequent rental periods. For example, as illustrated in FIG. 4, Job 4001 is processed over four rental periods. The timing of when Job 4001 is started during the 12 a.m. to 1 a.m. rental period may be determined such that the remainder of Job 4001 executes during the full rental period for one or more rental periods. As illustrated by FIG. 4, Job 4001 is scheduled such that a ten minute portion of the job is processed during the 12 a.m. to 1 a.m. rental period, and the remainder of the job is processed during subsequent rental periods.

As illustrated by FIG. 5, because Logical Device 2 only processes Job 4001 during the last ten minutes of the 12 a.m. to 1 a.m. rental period, idle time may exist between the completion of Job 1001 and the start of Job 4001. During the idle time, Logical Device 1 may not process any jobs. In an embodiment, one or more jobs may be processed by a logical device consecutively such that no idle time exists between jobs.

In an embodiment, it may be determined 308 whether a processing schedule includes one or more idle periods during a next rental period. An idle period may be a period of time in a rental period during which a logical device is not processing a job.

In an embodiment, in response to determining 308 that the processing schedule includes one or more idle periods, it may be determined 310 whether a future job is able to be processed during one of the idle periods. A future job may be a job that is scheduled to be processed during a subsequent rental period.

In an embodiment, a processing time associated with one or more identified future jobs may be compared to the length of time associated with one or more idle periods to determine whether a future job may be processed earlier than originally scheduled. If the processing time associated with a future job is less than or equal to the length of time associated with an idle period, the future job may be assigned to the idle period on the processing schedule.

For example, referring to FIG. 5, there is an idle period of approximately 18 minutes associated with Logical Device 1 after processing of Job 1003 completes. If the processing time for a future job is 15 minutes, the future job may be re-scheduled to be processed by Logical Device 1 after completion of Job 1003.

In an embodiment, if the processing time associated with a future job is greater than the length of time associated with an idle period, the future job may be assigned a start time during the idle period. In an embodiment, a future job may be assigned a start time during an idle period such that the completion time of the future job coincides with the end of a rental period. For example, referring to FIG. 6, Job 4001 may be assigned a start time of 12:50 a.m. because starting Job 4001 at this time may cause the completion time of Job 4001 (i.e., 4 a.m.) to coincide with the end of a rental period. In an alternate embodiment, a future job may be assigned a start time that coincides with the start time of the idle period. For example, referring to FIG. 6, Job 4001 may be assigned a start time of 12:40 a.m. such that no idle time exists during the 12 a.m.-1 a.m. time period.

In an embodiment, one or more logical devices may be instructed 312 to process the identified jobs according to the processing schedule. For example, the logical devices that are identified as operating during a next rental period may be instructed 312 to process the one or more jobs that are assigned to the logical devices during the rental period.

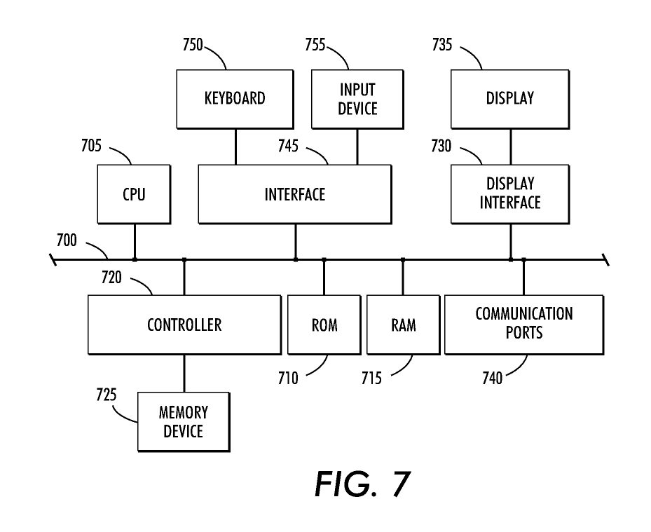

FIG. 7 depicts a block diagram of hardware that may be used to contain or implement program instructions according to an embodiment. A bus 700 serves as the main information highway interconnecting the other illustrated components of the hardware. CPU 705 is the central processing unit of the system, performing calculations and logic operations required to execute a program. Read only memory (ROM) 710 and random access memory (RAM) 715 constitute examples of memory devices.

A controller 720 interfaces with one or more optional memory devices 725 to the system bus 700. These memory devices 725 may include, for example, an external or internal DVD drive, a CD ROM drive, a hard drive, flash memory, a USB drive or the like. As indicated previously, these various drives and controllers are optional devices.

Program instructions may be stored in the ROM 710 and/or the RAM 715. Optionally, program instructions may be stored on a tangible computer readable storage medium such as a hard disk, compact disk, a digital disk, flash memory, a memory card, a USB drive, an optical disc storage medium, such as Blu-ray™ disc, and/or other recording medium.

An optional display interface 730 may permit information from the bus 700 to be displayed on the display 735 in audio, visual, graphic or alphanumeric format. Communication with external devices may occur using various communication ports 740. A communication port 740 may be attached to a communications network, such as the Internet or an intranet.

The hardware may also include an interface 745 which allows for receipt of data from input devices such as a keyboard 750 or other input device 755 such as a mouse, a joystick, a touch screen, a remote control, a pointing device, a video input device and/or an audio input device.

An embedded system, such as a sub-system within a xerographic apparatus, may optionally be used to perform one, some or all of the operations described herein. Likewise, a multiprocessor system may optionally be used to perform one, some or all of the operations described herein.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of scheduling a print job in a print production system, the method comprising:
identifying one or more print jobs having a start time within a rental period;
identifying one or more logical devices that are operating during the rental period;
determining, by a computing device, a processing schedule associated with the rental period, wherein determining a processing schedule comprises, for each identified print job, assigning the identified print job to a logical device from the one or more identified logical devices, wherein processing of each of the identified print jobs by the assigned logical device begins at the start time associated with the print job;
determining whether the processing schedule comprises an idle period;
in response to the processing schedule comprising an idle period, determining whether a future print job can be processed during the idle period;
in response to determining that the future print job can be processed during the idle period, assigning the future print job to at least a portion of the idle period on the processing schedule; and
instructing the identified logical devices to process the one or more identified print jobs according to the processing schedule.

2. The method of claim 1, wherein identifying one or more print jobs comprises:
receiving a plurality of print jobs to be processed; and
for each received print job:
determining a completion time associated with the print job,
determining a processing time associated with the print job, and
determining a start time associated with the print job based on at least the completion time and the processing time associated with the print job.

3. The method of claim 2, wherein determining a completion time associated with the print job comprises:
determining a receipt time associated with the print job, wherein the receipt time is the time at which the print job is received;
determining a turnaround time associated with the print job, wherein the turnaround time is specified by a service agreement governing the print job; and
determining a completion time by adding the turnaround time and the receipt time.

4. The method of claim 1, wherein identifying one or more logical devices that are operating during the rental period comprises identifying one or more logical devices that will finish processing print jobs at the end of a rental period that immediately precedes the rental period.

5. The method of claim 1, wherein identifying one or more logical devices that are operating during the rental period comprises:
determining a total number of logical devices needed to process the identified jobs;
determining a number of logical devices that will finish processing print jobs at the end of a rental period that immediately precedes the rental period; and
in response to the total number of logical devices exceeding the number of logical devices that will finish processing print jobs at the end of a rental period, activating a number of logical devices equal to a difference between the total number of logical devices and the number of logical devices that will finish processing print jobs at the end of a rental period.

6. The method of claim 1, wherein determining whether the processing schedule comprises an idle period comprises determining whether the processing schedule comprises a period of time during which at least one of the one or more logical devices is not processing an identified print job during the rental period.

7. The method of claim 1, wherein determining that a future print job can be processed during the idle period comprises determining whether a processing time associated with the future print job is less than or equal to a length of time associated with the idle period.

8. The method of claim 1, wherein determining that a future print job can be processed during the idle period comprises:
identifying a future print job having a processing time that exceeds a length of time associated with the idle period; and
determining whether starting the future print job during the idle period will result in the future print job completing at an end of a rental period that occurs after the rental period.

9. The method of claim 1, wherein assigning the future print job to at least a portion of the idle period on the processing schedule comprises assigning the future print job to start at a beginning of the idle period.

10. A system for scheduling a print job in a print production system, the system comprising:
a computing device; and
a computer-readable storage medium in communication with the computing device, wherein the computer-readable storage medium comprises one or more programming instructions that, when executed, cause the computing device to:
identify one or more print jobs having a start time within a rental period,
identify one or more logical devices that are operating during the rental period,
determine a processing schedule associated with the rental period, wherein determining a processing schedule comprises, for each identified print job, assigning the identified print job to a logical device from the one or more identified logical devices, wherein processing of each of the identified print jobs by the assigned logical device begins at the start time associated with the print job,
determine whether the processing schedule comprises an idle period,
in response to the processing schedule comprising an idle period, determine whether a future print job can be processed during the idle period,
in response to determining that the future job can be processed during the idle period, assign the future print job to at least a portion of the idle period on the processing schedule, and
instruct the identified logical devices to process the one or more identified print jobs according to the processing schedule.

11. The system of claim 10, wherein the one or more programming instructions that, when executed, cause the computing device to identify one or more print jobs comprise one or more programming instructions that, when executed, cause the computing device to:
receive a plurality of print jobs to be processed; and
for each received print job:
determine a completion time associated with the print job,
determine a processing time associated with the print job, and
determine a start time associated with the print job based on at least the completion time and the processing time associated with the print job.

12. The system of claim 11, wherein the one or more programming instructions that, when executed, cause the computing device to determine a completion time associated with the print job comprise one or more programming instructions that, when executed, cause the computing device to:
determine a receipt time associated with the print job, wherein the receipt time is the time at which the print job is received;
determine a turnaround time associated with the print job, wherein the turnaround time is specified by a service agreement governing the print job; and
determine a completion time by adding the turnaround time and the receipt time.

13. The system of claim 10, wherein one or more programming instructions that, when executed, cause the computing device to identify one or more logical devices that are operating during the rental period comprise one or more programming instructions that, when executed, cause the computing device to identify one or more logical devices that will finish processing print jobs at the end of a rental period that immediately precedes the rental period.

14. The system of claim 10, wherein the one or more programming instructions that, when executed, cause the computing device to identify one or more logical devices that are operating during the rental period comprise one or more programming instructions that, when executed, cause the computing device to:
determine a total number of logical devices needed to process the identified print jobs;
determine a number of logical devices that will finish processing print jobs at the end of a rental period that immediately precedes the rental period; and
in response to the total number of logical devices exceeding the number of logical devices that will finish processing print jobs at the end of a rental period, activate a number of logical devices equal to a difference between the total number of logical devices and the number of logical devices that will finish processing print jobs at the end of a rental period.

15. The system of claim 10, wherein the one or more programming instructions that, when executed, cause the computing device to determine whether the processing schedule comprises an idle period comprises one or more programming instructions that, when executed, cause the computing device to determine whether the processing schedule comprises a period of time during which at least one of the one or more logical devices is not processing an identified print job during the rental period.

16. The system of claim 10, wherein the one or more programming instructions that, when executed, cause the computing device to determine that a future print job can be processed during the idle period comprises one or more programming instructions that, when executed, cause the computing device to determine whether a processing time associated with the future print job is less than or equal to a length of time associated with the idle period.

17. The system of claim 10, wherein the one or more programming instructions that, when executed, cause the computing device to determine that a future print job can be processed during the idle period comprise one or more programming instructions that, when executed, cause the computing device to:
identify a future print job having a processing time that exceeds a length of time associated with the idle period; and
determine whether starting the future print job during the idle period will result in the future print job completing at an end of a rental period that occurs after the rental period.

18. The system of claim 10, wherein the one or more programming instructions that, when executed, cause the computing device to assign the future print job to at least a portion of the idle period on the processing schedule comprise one or more programming instructions that, when executed, cause the computing device to assign the future print job to start at a beginning of the idle period.

19. A method of scheduling a job, the method comprising:
identifying one or more jobs having a start time within a rental period;
identifying one or more logical devices that are operating during the rental period;
determining, by a computing device, a processing schedule associated with the rental period, wherein determining a processing schedule comprises, for each identified job, assigning the identified job to a logical device from the one or more identified logical devices, wherein processing of each of the identified jobs by the assigned logical device begins at the start time associated with the job;
determining whether the processing schedule comprises an idle period;
in response to the processing schedule comprising an idle period, determining whether a future job can be processed during the idle period;
in response to determining that the future job can be processed during the idle period, assigning the future job to at least a portion of the idle period on the processing schedule; and
instructing the identified logical devices to process the one or more identified jobs according to the processing schedule.

20. The method of claim 19, wherein identifying one or more jobs comprises:
receiving a plurality of jobs to be processed; and
for each received job:
determining a completion time associated with the job,
determining a processing time associated with the job, and
determining a start time associated with the job based on at least the completion time and the processing time associated with the job.

21. The method of claim 20, wherein determining a completion time associated with the job comprises:
determining a receipt time associated with the job, wherein the receipt time is the time at which the job is received;
determining a turnaround time associated with the job, wherein the turnaround time is specified by a service agreement governing the job; and
determining a completion time by adding the turnaround time and the receipt time.

22. The method of claim 19, wherein identifying one or more logical devices that are operating during the rental period comprises identifying one or more logical devices that will finish processing jobs at the end of a rental period that immediately precedes the rental period.

23. The method of claim 19, wherein identifying one or more logical devices that are operating during the rental period comprises:
determining a total number of logical devices needed to process the identified jobs;
determining a number of logical devices that will finish processing jobs at the end of a rental period that immediately precedes the rental period; and
in response to the total number of logical devices exceeding the number of logical devices that will finish processing jobs at the end of a rental period, activating a number of logical devices equal to a difference between the total number of logical devices and the number of logical devices that will finish processing jobs at the end of a rental period.

24. The method of claim 19, wherein determining whether the processing schedule comprises an idle period comprises determining whether the processing schedule comprises a period of time during which at least one of the one or more logical devices is not processing an identified job during the rental period.

25. The method of claim 19, wherein determining that a future job can be processed during the idle period comprises determining whether a processing time associated with the future job is less than or equal to a length of time associated with the idle period.

26. The method of claim 19, wherein determining that a future job can be processed during the idle period comprises:
identifying a future job having a processing time that exceeds a length of time associated with the idle period; and
determining whether starting the future job during the idle period will result in the future job completing at an end of a rental period that occurs after the rental period.

27. The method of claim 19, wherein assigning the future job to at least a portion of the idle period on the processing schedule comprises assigning the future job to start at a beginning of the idle period.
